(19) United States
(12) Patent Application Publication
(10) Pub. No.: US 2022/0179727 A1
(43) Pub. Date: Jun. 9, 2022

(54) A METHOD AND SYSTEM TO ENABLE AN APPLIANCE TO COMMUNICATE

(71) Applicant: CARRIER CORPORATION, Palm Beach Gardens, FL (US)

(72) Inventor: Praneeth Madamshetty, Hyderabad, Telangana (IN)

(21) Appl. No.: 17/252,643

(22) PCT Filed: Jul. 22, 2020
(86) PCT No.: PCT/IB2020/056872

§ 371 Date: Dec. 15, 2020

(30) Foreign Application Priority Data
Aug. 28, 2019 (IN) 201911034587

(51) Int. Cl. G06F 11/07; G06F 3/16

(52) U.S. Cl. CPC G06F 11/0748; G06F 3/167; G06F 11/0775

(57) ABSTRACT

Aspects of the invention are directed towards a system and a method for enabling an appliance to communicate. One or more embodiments of the invention describe the method comprising steps of detecting an event associated with an appliance by an electronic circuit, the electronic circuit coupled with the appliance. One or more embodiments of the invention further describe steps of determining a code corresponding to the detected event and converting the code to an audio signal. Accordingly, the audio signal is transmitted to a virtual assistance device communicably coupled with the appliance.

### CROSS-REFERENCE TO RELATED APPLICATION

This application is a National Application of PCT/IB2020/056872, filed Jul. 22, 2020, which claims priority to India Application No. 201911034587, filed Aug. 28, 2019, the disclosures of which are incorporated herein by reference in their entirety.

### TECHNICAL FIELD OF INVENTION

The present invention generally relates to appliances. More particularly, the invention relates to a system and a method for enabling an appliance to communicate.

### BACKGROUND OF THE INVENTION

With the advancement in technology in all areas of consumer electronics, there are numerous smart appliances for consumers available in the market. These appliances are immensely helpful for consumers as they provide automatic and faster ways of doing daily and mundane tasks. Due to the dependence of consumers on such appliances, these are popular and always remain in high demand.

However, at present, such appliances are unable to communicate. Further, these appliances do not possess any capability to automatically diagnose any error/problem associated with them. As a result, it is only when an appliance does not work or stops functioning, the consumer learns about any error/problem in the appliance. When the consumer comes to know about an error/problem in the appliance, then the consumer tries to connect with a technician or a manufacturer of the appliance to report the error/problem in the appliance. Thereafter, a technician or a representative is assigned by the manufacturer, who checks the appliance and tries to identify the exact error/problem in the appliance due to which the appliance has stopped working. This existing way of diagnosing the error/problem associated with an appliance and reporting the error/problem to a technician requires manual intervention by the consumer.

In view of the afore-mentioned problems in the existing solutions, there is a need of an efficient and effective system and a method for automatically enabling an appliance to detect problem/error associated with the appliance. There is also a need for enabling an appliance to communicate a problem/error in a more efficient manner by reducing manual intervention. In order to solve the problems in the existing solutions, a system and a method are disclosed.

### SUMMARY OF THE INVENTION

Various embodiments of the invention describe a method for enabling an appliance to communicate with a virtual assistance device. The method comprises the steps of detecting an event associated with an appliance by an electronic circuit, the electronic circuit being coupled with the appliance. The method further comprises steps of determining a code corresponding to the detected event and converting the code to an audio signal. Accordingly, the audio signal is transmitted to a virtual assistance device communicably coupled with the appliance.

In an embodiment of the invention, the event corresponds to a diagnostic information, an error or an alert related to the appliance.

In another embodiment of the invention, the event is associated with one or more components of the appliance.

In yet another embodiment of the invention, the code corresponding to the detected event is pre-configured in the appliance.

In still another embodiment of the invention, the code corresponding to the detected event is a textual code, the textual code comprising an alpha-numeric code, a number code, or an alphabetical code.

In another embodiment of the invention, the virtual assistance device transmits a message to a service provider based on the audio signal.

In yet another embodiment of the invention, the appliance is a home appliance. Further, the home appliance is an air conditioner unit, a coffee machine, a washing machine, a geyser, a television, a microwave/oven or a refrigerator.

In a different embodiment of the invention, an electronic circuit coupled with an appliance is disclosed for enabling an appliance to communicate with a virtual assistance device. The electronic circuit comprises one or more sensors adapted to detect an event associated with the appliance and a determination unit adapted to determine a code corresponding to the detected event. The electronic circuit further comprises an audio converter adapted to convert the code to an audio signal and a transmitter adapted to transmit the audio signal to a virtual assistance device communicably coupled with the appliance.

In an embodiment of the invention, the event corresponds to a diagnostic information, an error or an alert related to the appliance.

In another embodiment of the invention, the event is associated with one or more components of the appliance.

In yet another embodiment of the invention, the code corresponding to the detected event is pre-configured in the appliance.

In still another embodiment of the invention, the code corresponding to the detected event is a textual code, the textual code comprising an alpha-numeric code, a number code, or an alphabetical code.

In another embodiment of the invention, the virtual assistance device transmits a message to a service provider based on the audio signal.

In yet another embodiment of the invention, the appliance is a home appliance.

In another different embodiment of the invention, a computer readable medium is disclosed for enabling an appliance to communicate with a virtual assistance device. The computer readable medium comprises one or more processors and a memory coupled to the one or more processors, memory storing instructions executed by the one or more processors. The memory storing instructions which are executed by the one or more processors are configured to detect an event associated with an appliance by an electronic circuit, the electronic circuit coupled with the appliance. The memory storing instructions which are executed by the one or more processors are further configured to determine a code corresponding to the detected event and convert the code to an audio signal. The memory storing instructions which are executed by the one or more processors are further configured to transmit the audio signal to a virtual assistance device communicably coupled with the appliance.

In an embodiment of the invention, the event corresponds to a diagnostic information, an error or an alert related to the appliance.

In another embodiment of the invention, the event is associated with one or more components of the appliance.

In yet another embodiment of the invention, the code corresponding to the detected event is pre-configured in the appliance.

In still another embodiment of the invention, the code corresponding to the detected event is a textual code, the textual code comprises an alpha-numeric code, a number code, or an alphabetical code.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Other aspects, advantages, and salient features of the invention will become apparent to those skilled in the art from the following detailed description, which, taken in conjunction with the annexed drawings, disclose exemplary embodiments of the invention.

### BRIEF DESCRIPTION OF THE DRAWINGS

FIG. 1 depicts an exemplary system architecture according to an exemplary embodiment of the invention.

FIG. 2 depicts block diagram of different components of an electronic circuit coupled with an appliance according to an exemplary embodiment of the invention.

FIG. 3 depicts an exemplary flowchart illustrating a method to perform the invention according to an exemplary embodiment of the invention.

Corresponding reference numerals indicate corresponding parts throughout the drawings.

### DETAILED DESCRIPTION OF THE INVENTION

Described herein is technology with an electronic circuit and a method for detecting event/s associated with an appliance and communicating the event/s to a virtual assistance device. Further, the event/s may be associated with one or more components of the appliance.

As used herein, the appliance may be a home appliance and can be used by a consumer in any building. Such a building may be a home, an office, a school, a college, a university, a hotel, a hospital, a hostel or the like. Further, the appliance may be communicably coupled with a virtual assistance device. Such an appliance may be an air conditioner unit, a coffee machine, a washing machine, a geyser, a television, a microwave/oven, a refrigerator or any such appliance or electronic device that is well known in the art.

As used herein, the event may be associated with the appliance or with one or more components of the appliance. Further, the event may correspond to a diagnostic information, an error or an alert related to the appliance. Further details on the event have been discussed below in greater detail.

As used herein, the virtual assistance device may be a device having an integrated virtual assistance. Such a virtual assistance device may be communicably coupled with the appliance. The virtual assistance device may be a desktop computer or a hand held device such as a mobile phone with network connectivity. Examples of the virtual assistance device may include a stand-alone device, a desktop, a workstation PC, a laptop, a smart phone, a tablet, a wearable device and the like.

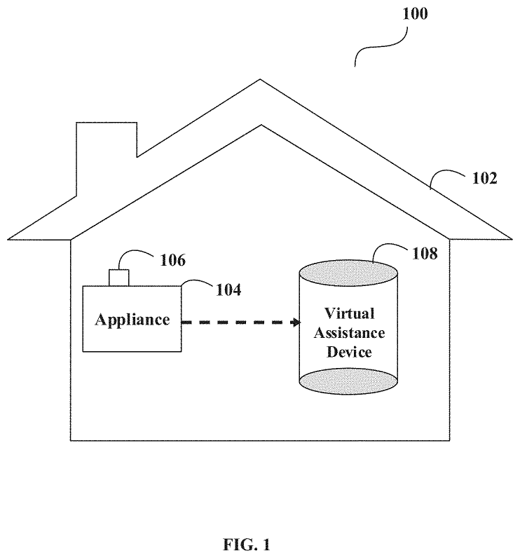

FIG. 1 depicts a system architecture 100 for detecting an event associated with an appliance and communicating the event to a virtual assistance device, according to an exemplary embodiment of the invention. As depicted in FIG. 1, a building 102, an appliance 104 placed in the building 102, an electronic circuit 106 coupled with the appliance 104, and a virtual assistance device 108 communicably coupled with the appliance 104. In an exemplary embodiment, the virtual assistance device 108 may also be placed in the building 102. Although FIG. 1 depicts the electronic circuit 106 positioned on top of the appliance 104, however, it is understood for a person skilled in the art that the electronic circuit 106 can be positioned anywhere on the appliance 104.

The electronic circuit 106 coupled with the appliance 104 may detect an event associated with one or more components of the appliance 104 or with the appliance 104. Such an event may correspond to a diagnostic information, an error or an alert related to the appliance 104. In particular, the electronic circuit 106 may periodically diagnose functioning of the appliance 104 or functioning of the one or more components of the appliance 104. When the electronic circuit 106 diagnoses that the appliance 104 or the one or more components of the appliance 104 is not functioning properly or has stopped working, then the electronic circuit 106 may detect such an event. Alternatively, when a maintenance alert of the appliance 104 is required or is pending on a particular date, then the electronic circuit 106 coupled with the appliance 104 may detect such an event.

When the electronic circuit 106 detects an event associated with the appliance 104, the electronic circuit 106 may determine a code corresponding to the detected event. Such a code corresponding to the detected event may be pre-configured in the appliance 104 during the manufacturing of the appliance 104 or before dispatching the appliance 104 to the market for sale. In an exemplary embodiment, the code corresponding to the detected event is a textual code. Such textual code comprises an alpha-numeric code, a number code, or an alphabetical code. This has been explained below with an exemplary scenario.

The electronic circuit 106 may convert the determined code (corresponding to the detected event) to an audio signal. Further, the electronic circuit 106 may transmit the audio signal to the virtual assistance device 108 communicably coupled with the appliance 104. In particular, the electronic circuit 106 may have an ability to verbally communicate the audio signal through a speaker present in the appliance 104. When the speaker in the appliance 104 verbally communicates the audio signal, the verbal audio signal may be transmitted to the virtual assistance device 108 through the air or through any other transmission medium known in the art. The virtual assistance device 108 may receive the audio signal and recognize the audio signal verbally communicated by the electronic circuit 106 of the appliance 104. On recognizing the audio signal, the virtual assistance device 108 may automatically transmit a message to a service provider based on the audio signal. In particular, the virtual assistance device 108 may identify a contact number/e-mail of the service provider and then transmit the message to the service provider. The contact number/email of the service provider may be pre-stored in the virtual assistance device 108 or any other connected device to the virtual assistance device 108. As used herein, the service provider may be a manufacturer of the appliance 104, a dealer of the appliance 104, an owner of the appliance 104, a technician of the appliance 104, an insurance provider of the appliance 104, or any other service provider of the appliance 104.

Exemplary Table 1 below depicts three exemplary events detected by an electronic circuit of an air conditioner (AC) appliance.

TABLE 1
Appliance-Air Conditioner
AC Identifier-AC123XXX

| | | | Contact number | Message to |
|---|---|---|---|---|
| | | | of Service | Service |
| Event | Code | Company | Provider | Provider |
| Compressor | EEAC01 | Manufacturing | xyxyxyxyxy | Error code |
| Motor not | | company | | EEAC01 |
| working | | “ABC” | | reported from |
| | | | | AC123XXX |
| Condenser | EEAC05 | Insurance | xyxyxyxyxy | Error code |
| Coil | | company | | EEAC05 |
| Damaged | | “ABC” | | reported from |
| | | | | AC123XXX |
| Alert- | AEAC01 | Insurance | xxxxxxxxxx | Alert code |
| Maintenance | | company | | AEAC01 |
| pending for | | “XYZ” | | reported from |
| Aug. 31, | | | | AC123XXX |
| 2019 | | | | |

The three exemplary detected events are Compressor Motor not working, Condenser Coil Damaged and Alert—Maintenance pending for Aug. 31, 2019 and the corresponding exemplary codes for these detected events are EEAC01, EEAC05, and AEAC01 respectively. In the corresponding exemplary codes EEAC01, EEAC05, and AEAC01, the term EE may be an abbreviated form of “Error Event”, the term AC may be an abbreviated form of “Air Conditioner” and the term AE may be an abbreviated form of “Alert Event”. When the electronic circuit of the air conditioner appliance determines the codes corresponding to the detected events, then the electronic circuit may convert these codes to audio signal and may transmit the audio signal to a virtual assistance device as discussed above. The virtual assistance device may use the contact number/email of service providers and accordingly send the message to the service providers. As shown in Table 1 above, the virtual assistance device may send the message such as “Error code EEAC01 reported from AC123XXX”, “Error code EEAC05 reported from AC123XXX” and “Alert code AEAC01 reported from AC123XXX” to contact numbers of service providers, xyxyxyxyxy, xyxyxyxyxy and xxxxxxxxxx, respectively. The events, the corresponding codes, the contact numbers of service providers and the messages to service providers used in the exemplary Table 1 above are only for explanation purpose to enhance the intelligibility of the subject matter. Although the exemplary Table 1 above describes the present invention for the air conditioner appliance, however, it is well-understood to a person skilled in the art that such exemplary table can be taken as an example for other appliances as well. It is also to be noted here that each appliance may have different types of components, different events, different corresponding codes, different contact numbers/communication means and different messages for service providers. It shall entirely depend upon the manufacturer of the appliance to choose different events, different corresponding codes, different contact numbers and different messages for service providers for the appliance.

In another exemplary scenario, the virtual assistance device 108 may identify a contact number/e-mail of an owner of the appliance 104 and then transmit a text message or an email message to the owner of the appliance 104. On receiving the text message or the email message, the owner of the appliance 104 may accordingly decide action/s to be taken in order to resolve the event occurred in the appliance 104. Such an action/s may be taken by the owner at the same time when the text message or the email message is received or may be taken at a later time. For an example, the action include booking a repair session for the appliance 104 etc. Alternatively, the virtual assistance device 108 may transmit an audio message to the owner of the appliance 104 if the owner of the appliance 104 is present proximate to the virtual assistance device 108.

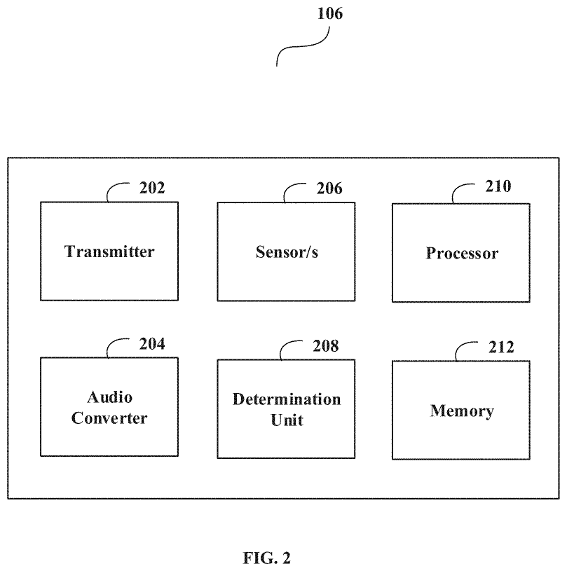

FIG. 2 depicts a block diagram of different components of an electronic circuit 106 coupled with an appliance 104, according to an exemplary embodiment of the invention. The electronic circuit 106 may comprise of, but is not limited to, a transmitter 202, an audio converter 204, one or more sensors 206, a determination unit 208, a processor 210 and a memory 212. The one or more sensors 206 may be adapted to detect an event associated with one or more components of the appliance 104 or may be associated with the appliance 104. Such an event may correspond to a diagnostic information, an error or an alert related to the appliance 104. In particular, the one or more sensors 206 may periodically diagnose functioning of the appliance 104 or functioning of the one or more components of the appliance 104 as explained above. The determination unit 208 may be adapted to receive detected event from the one or more sensors 206 and the determination unit 208 may also be adapted determine a code corresponding to the detected event. The audio converter 204 may be adapted to receive the determined code from the determination unit 208 and the audio converter 204 may also be adapted to convert the determined code (corresponding to the detected event) to an audio signal. The transmitter 202 may be adapted to receive the audio signal from the audio converter 204 and the transmitter 202 may also be adapted to transmit the audio signal to the virtual assistance device 108 communicably coupled with the appliance 104 as discussed above. The memory 212 may be adapted to store an identifier associated with the appliance 104, store the event/s, one or more codes corresponding to the detected event etc. The transmitter 202, the audio converter 204, the one or more sensors 206, the determination unit 208 and/or the memory 212 may be communicably coupled with the processor 210.

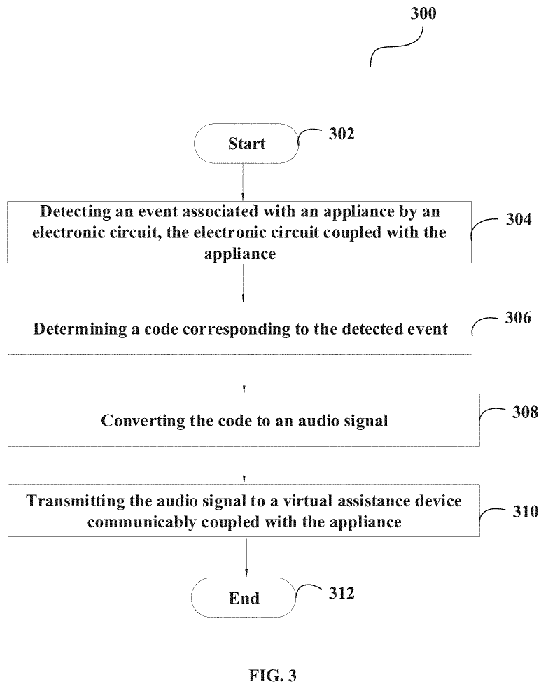

FIG. 3 depicts a flowchart outlining the features of the invention in an exemplary embodiment of the invention. The method flowchart 300 describes a method being performed for detecting an event associated with an appliance 104 and communicating the event to a virtual assistance device 108. The method flowchart 300 starts at step 302.

At step 304, the electronic circuit 106 coupled with the appliance 104 may detect an event associated with one or more components of the appliance 104 or may be associated with the appliance 104. Such event may correspond to a diagnostic information, an error or an alert related to the appliance 104. In particular, the electronic circuit 106 may periodically diagnose functioning of the appliance 104 or functioning of the one or more components of the appliance 104.

At step 306, the electronic circuit 106 may determine a code corresponding to the detected event. Such code corresponding to the detected event may be pre-configured in the appliance 104 during the manufacturing time of the appliance 104 or before dispatching the appliance 104 to the market for sale. In an exemplary embodiment, the code corresponding to the detected event is a textual code. Such textual code comprises an alpha-numeric code, a number code, or an alphabetical code.

At step 308, the electronic circuit 106 may convert the determined code (corresponding to the detected event) to an audio signal.

At step 310, the electronic circuit 106 may transmit the audio signal to the virtual assistance device 108 communicably coupled with the appliance 104. In particular, the electronic circuit 106 may have an ability to verbally communicate the audio signal through a speaker present in the appliance 104. When the speaker in the appliance 104 verbally communicates the audio signal, the audio signal may be transmitted to the virtual assistance device 108 through the air or any other transmission medium known in the art. The method flowchart may end at 312.

The present invention is applicable to various fields/industries such as, but is not limited to, hospitality industry, hostels, educational institutes, homes, offices, or any such field/industry where the appliance can be used and is obvious to a person skilled in the art.

The present invention provides the following technical advantages over the existing solutions a) automatically convert a dumb appliance to a smart appliance, b) enables the appliance to automatically communicate with a virtual assistance device, c) enables the appliance to automatically detect events associated with one or more components of the appliance, and d) eliminates the need of manual intervention for connecting with service providers, and e) enables the appliance communicate with a virtual assistance device without using an internet connectivity.

The embodiments of the invention and the tables discussed herein are exemplary and various modification and alterations to a person skilled in the art are within the scope of the invention.

In one embodiment of the invention, the invention can be operated using the one or more computer readable devices. The one or more computer readable devices can be associated with an electronic circuit 106. A computer readable medium comprising one or more processors and a memory coupled to the one or more processors, the memory storing instructions which are executed by the one or more processors, the one or more processors configured to detect an event associated with an appliance 104 by an electronic circuit 106, the electronic circuit 106 coupled with the appliance 104. The memory storing instructions which are executed by the one or more processors, the one or more processors configured to determine a code corresponding to the detected event and convert the code to an audio signal. The memory storing instructions which are executed by the one or more processors, the one or more processors also configured to transmit the audio signal to a virtual assistance device 108 communicably coupled with the appliance 104. In an embodiment of the invention, the event corresponds to a diagnostic information, an error or an alert related to the appliance.

In another embodiment of the invention, the event corresponds to a diagnostic information, an error or an alert related to the appliance 104 and may be associated with one or more components of the appliance 104. Also, the code corresponding to the detected event is pre-configured in the appliance 104. Further, the code corresponding to the detected event is a textual code, the textual code comprises an alpha-numeric code, a number code, or an alphabetical code.

Exemplary computer readable media includes flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this invention are not signals per se. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, examples of the invention are capable of implementation with numerous other general purpose or special purpose computing system environments, configurations, or devices.

Examples of the invention may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the Figures/Tables and described herein. Other examples of the invention may include different computer-executable instructions or components having more or less functionality than illustrated and described herein.

Aspects of the invention transform a general-purpose computer into a special-purpose computing device when configured to execute the instructions described herein.

The order of execution or performance of the operations in examples of the invention illustrated and described herein is not essential, unless otherwise specified. That is, the operations may be performed in any order, unless otherwise specified, and examples of the invention may include additional or fewer operations than those disclosed herein. For example, it is contemplated that executing or performing a particular operation before, contemporaneously with, or after another operation is within the scope of aspects of the invention.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “data store,” “data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Furthermore, the terms “user,” “subscriber,” “customer,” “consumer,” “agent,” and the like are employed interchangeably throughout the subject specification, unless context warrants particular distinction(s) among the terms. Such terms can refer to human entities or automated components supported through artificial intelligence (e.g., a capacity to make inference based on complex mathematical formalisms) which can provide simulated vision, sound recognition and so forth.

When introducing elements of aspects of the invention or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C”.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
detecting an event associated with an appliance by an electronic circuit, the electronic circuit coupled with the appliance;
determining a code corresponding to the detected event;
converting the code to an audio signal; and
transmitting the audio signal to a virtual assistance device communicably coupled with the appliance.

2. The method of claim 1, wherein the event corresponds to a diagnostic information, an error or an alert related to the appliance.

3. The method of claim 1, wherein the event is associated with one or more components of the appliance.

4. The method of claim 1, wherein the code corresponding to the detected event is pre-configured in the appliance.

5. The method of claim 1, wherein the code corresponding to the detected event is a textual code, the textual code comprises an alpha-numeric code, a number code, or an alphabetical code.

6. The method of claim 1, wherein the virtual assistance device transmits a message to a service provider based on the audio signal.

7. The method of claim 1, wherein the appliance is a home appliance.

8. The method of claim 7, wherein the home appliance is an air conditioner unit, a coffee machine, a washing machine, a geyser, a television, a microwave/oven or a refrigerator.

9. An electronic circuit coupled with an appliance, the electronic circuit comprising:
one or more sensors adapted to detect an event associated with the appliance;
a determination unit adapted to determine a code corresponding to the detected event;
an audio converter adapted to convert the code to an audio signal; and
a transmitter adapted to transmit the audio signal to a virtual assistance device communicably coupled with the appliance.

10. The electronic circuit of claim 9, wherein the event corresponds to a diagnostic information, an error or an alert related to the appliance.

11. The electronic circuit of claim 9, wherein the event is associated with one or more components of the appliance.

12. The electronic circuit of claim 9, wherein the code corresponding to the detected event is pre-configured in the appliance.

13. The electronic circuit of claim 9, wherein the code corresponding to the detected event is a textual code, the textual code comprises an alpha-numeric code, a number code, or an alphabetical code.

14. The electronic circuit of claim 9, wherein the virtual assistance device transmits a message to a service provider based on the audio signal.

15. The electronic circuit of claim 9, wherein the appliance is a home appliance.

16. A computer readable medium comprising one or more processors and a memory coupled to the one or more processors, the memory storing instructions executed by the one or more processors, the one or more processors configured to:
detect an event associated with an appliance by an electronic circuit, the electronic circuit coupled with the appliance;
determine a code corresponding to the detected event;
convert the code to an audio signal; and
transmit the audio signal to a virtual assistance device communicably coupled with the appliance.

17. The computer readable medium of claim 16, wherein the event corresponds to a diagnostic information, an error or an alert related to the appliance.

18. The computer readable medium of claim 16, wherein the event is associated with one or more components of the appliance.

19. The computer readable medium of claim 16, wherein the code corresponding to the detected event is pre-configured in the appliance.

20. The computer readable medium of claim 16, wherein the code corresponding to the detected event is a textual code, the textual code comprises an alpha-numeric code, a number code, or an alphabetical code.
